(19) United States
(12) Patent Application Publication
(10) Pub. No.: US 2026/0359031 A1
(43) Pub. Date: Nov. 12, 2026

(54) Intelligent Remote Actions Orchestrator

(71) Applicant: Zscaler, Inc., San Jose, CA (US)

(72) Inventors: Tejas Budukh, Fremont, CA (US); Prasanna Jobigenahally Malleshaiah, Sunnyvale, CA (US); Satish Kalipatnapu, Alpharetta, GA (US); Saroj Panigrahy, Fremont, CA (US); Purvi Desai, Mountain View, CA (US); Karthik Gottiparthy, Livermore, CA (US)

(73) Assignee: Zscaler, Inc., San Jose, CA (US)

(21) Appl. No.: 19/202,267

(22) Filed: May 8, 2025

(51) Int. Cl. G06F 8/65

(52) U.S. Cl. CPC G06F 8/65

(57) ABSTRACT

Systems and methods for orchestrating remote operations in an enterprise network are provided. According to one implementation, a method includes a step of receiving telemetry information from a plurality of endpoint devices in an enterprise network, the telemetry information including device health data related to the health of the plurality of endpoint devices, network status data related to the status of the enterprise network, and active application data related to the use of applications on the plurality of endpoint devices. Furthermore, the method includes a step of orchestrating remote operations to be performed on the plurality of endpoint devices based on the device health data, network status data, and active application data.

### TECHNICAL FIELD

The present disclosure generally relates to customer support and ticketing systems. More particularly, the present disclosure relates to automated ticketing systems configured to create a customized workflow partitioned between local and remote execution and orchestrating enterprise operations remotely.

### BACKGROUND

Service desk and IT workflows often span internal and external systems for handling tickets. An IT specialist or service desk engineer typically may need to orchestrate various tasks manually to complete an entire sequence. Some of these tasks may include initiating or pre-processing a new ticket, collecting logs, running analysis, etc. The manual coordination of such tasks, particularly with respect to multiple tickets for multiple users, can be a complex and time-consuming job for these service desk technicians. Also, many IT operations (e.g., issuing a widespread software upgrade) may involve control or management over multiple devices within a certain timeframe. However, these operations can also be complex, particularly since each device may be utilized differently (e.g., based on various work schedules for different individuals) and since they may encounter different network issues. Therefore, there is a need in the field of ticketing systems for improvements thereof, particularly to account for both the overall processing of ticketing workflows as well as to account for remotely managed operations for a group of user devices.

### BRIEF SUMMARY

The present disclosure is directed to ticket management systems and methods. In a first implementation, a method may be configured for creating a ticket workflow. The method, for example, may include a step of receiving a job request related to one or more endpoint devices employed in an enterprise network. Based on the job request, the method further includes a step of automatically creating a ticketing workflow having a plurality of tasks following a Directed Acyclic Graph (DAG) format with vertices and edges such that the ticketing workflow proceeds in one direction without cycling to a previous vertex. Also, the method includes a step of partitioning the ticketing workflow into parallel subgraphs for concurrent orchestration and execution, wherein one or more subgraphs are configured for execution by one or more cloud-based devices and one or more subgraphs are configured for execution by one or more local devices.

According to additional embodiments, the one or more local devices, for example, may include an IT/admin device and the one or more endpoint devices. In some embodiments, the method may include a step of receiving input from a service desk engineer for managing the ticketing workflow. The one or more cloud-based devices, for example, may include a back-end orchestration system for execution of a subgraph of the ticketing workflow. The step of receiving the job request may include using a Natural Language Processing (NLP) API to obtain ticket information regarding tasks to be completed, scheduling, threshold analysis, and conditional actions for creating the ticketing workflow. In some embodiments, the ticketing workflow may include a vertex for consolidating results from the parallel subgraphs in order to provide a final report. Also, the method may further include a step of displaying the results on a dashboard or User Interface (UI) to allow a service desk engineer to track aspects and progress of the ticketing workflow.

Furthermore, the method may include steps of a) monitoring multiple applications running in the enterprise network, b) incorporating tasks of the multiple applications into the ticketing workflow using a holistic approach, and c) scheduling the tasks in subgraphs. For example, the multiple applications may be related to services or products including a) network performance analysis, b) network security management, c) data security management, d) identity verification, e) malware detection, f) device/system/network health analysis, g) mobile device management, h) log collection tools, i) sentiment analysis services, j) remote script execution tools, and/or k) intelligent log analysis tools. Also, the multiple applications may include in-house and/or third-party services and products.

In some implementations, a plurality of the tasks of the ticketing workflow may be automated. Also, the method may further include a step of reusing the ticketing workflow within the enterprise network on a periodic basis to troubleshoot persistent issues. The step of partitioning, for example, may include analyzing one or more of a) available resources arranged locally and in the cloud, b) tasks to be performed, c) security constraints of different resources, d) which resources are best suited for performing the tasks, and e) time characteristics of the tasks and resources to optimize speed, in order to intelligently optimize the partitioning with respect to time, efficiency, security, and accuracy.

In a second implementation, another method for performing a remote orchestration procedure may be executed. For example, the method in this second implementation includes a step of receiving telemetry information from a plurality of endpoint devices in an enterprise network, wherein the telemetry information includes device health data related to the health of the plurality of endpoint devices, network status data related to the status of the enterprise network, and active application data related to the use of applications on the plurality of endpoint devices. In addition, the method includes a step of orchestrating remote operations to be performed on the plurality of endpoint devices based on the device health data, network status data, and active application data.

In some embodiments, the remote operations may be related to a roll-out procedure for rolling out a) new software, b) a software or firmware update, and/or c) a software fix or patch with respect to one or more software applications on each of the plurality of endpoint devices. The roll-out procedure, for example, may be performed in groups of endpoint devices, wherein a first group is a trial group configured to send feedback with respect to the success of the roll-out procedure. In response to receiving feedback from the trial group that the roll-out procedure results in performance metrics within acceptable thresholds, the method may further include a step of progressively expanding the roll-out procedure to continue to the next group. In response to receiving feedback from the trial group that the roll-out procedure results in performance metrics outside of acceptable thresholds, the method may further include steps of 1) halting the roll-out procedure and 2) rolling back changes of the roll-out procedure.

According to some implementations, the telemetry information may be real-time telemetry information that further includes calendar data that is related to scheduled activities of a plurality of users of the plurality of endpoint devices. In some embodiments, the step of orchestrating may include scheduling the remote operations to avoid disruptions a) that would negatively affect productivity of the plurality of users, b) based on the calendar information, c) based on trends regarding hours when the plurality of users are active and inactive, and/or d) based on information regarding low-impact working time periods.

The step of orchestrating, for example, may include predictive scheduling based on use of a Machine Learning (ML) model that utilizes historical data and real-time data. In some cases, the method may further include a step of using context aware data integration to determine optimal timing of the remote operations when the endpoint devices are idle and/or when user productivity is least affected. The remote operations, for instance, may include script executions, surveys, device updates, mitigating issues in the private enterprise network, tracking device health metrics, network conditions, application status, and/or calendar integration. Based on evolving endpoint conditions and user activity, the method may further include a step of reprioritizing tasks and/or remote operations as needed. Also, the method may further include a step of receiving a trigger signal from a service desk operator to initiate execution of the remote operations.

According to an additional embodiment, another method for implementing an automated help desk is provided in order to remediate User Experience (UX) issues or other adverse conditions in an enterprise network. According to some implementations, the method includes a step of monitoring an enterprise network. In response to detecting one or more adverse conditions of the enterprise network that imply a decline in one or more UX metrics, the method includes a step of automatically collecting data logs from the enterprise network. Next, the method includes a step of automatically analyzing the data logs. In response to determining that the data logs indicate one or more issues in the enterprise network, the method includes a step of suggesting actions to remediate the one or more issues.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a block diagram illustrating a ticketing system for processing customer service tickets using Large Language Models (LLMs), according to various embodiments.

FIG. 2 is a block diagram illustrating another ticketing system using an LLM, according to various embodiments.

FIG. 3 is a block diagram illustrating a ticket managing system for an enterprise, according to various embodiments.

FIG. 4 is a block diagram illustrating a computing system of the back-end orchestration system shown in FIG. 3, according to various embodiments.

FIG. 5 is a block diagram illustrating a computing system of the IT/admin device shown in FIG. 3, according to various embodiments.

FIG. 6 is a diagram illustrating a ticket processing workflow having a Directed Acyclic Graph (DAG) that is generated by the workflow creation program shown in FIG. 4, according to various embodiments.

FIG. 7 shows an example of a ticketing workflow created to address Wi-Fi issues experienced by users within the enterprise, according to various embodiments.

FIG. 8 is a flow diagram illustrating a method for creating a ticket workflow, according to various embodiments.

FIG. 9 is a flow diagram illustrating a method for performing a remote orchestration procedure, according to various embodiments.

### DETAILED DESCRIPTION

The present disclosure relates to systems and methods associated with customer service or customer support platforms, particularly ticketing systems, for managing tickets regarding issues within a network. As described herein, a “ticket” (e.g., customer service ticket, customer support ticket, and the like) refers to a record of a customer's interaction with a service representative and may be a key part of a business's customer support framework. In the present disclosure, the ticketing systems may be partially or fully automated, thereby reducing or eliminating the responsibilities of the service representative and replacing the human factor in this regard with chatbot systems, Large Language Models (LLMs), Artificial Intelligence (AI) models, Machine Learning (ML) models, etc. For example, cybersecurity entities (e.g., a cloud service provider) may handle multiple tickets every day for resolving security issues and other customer issues that arise during network operation. The embodiments described herein are configured to leverage LLMs to dynamically summarize ticket information.

A customer service ticket may be a formal request from a customer for help with a specific problem, a question regarding network operations (e.g., security applications within a domain), chat queries, problem reporting, etc. With automated assistance, solutions to customer problems may include answers that satisfy the customer’s concerns, automated resolutions, network reconfigurations, debugging, measuring, and testing network equipment, and the like. Customer service tickets may be managed by the systems and methods of the present disclosure through a helpdesk-type ticketing system, which can help organizations (e.g., cybersecurity companies) track, monitor, prioritize, and categorize various tickets they receive from their customers. With the assistance of LLMs, the organizations can provide better and faster resolution of customer issues, thereby providing a better customer experience.

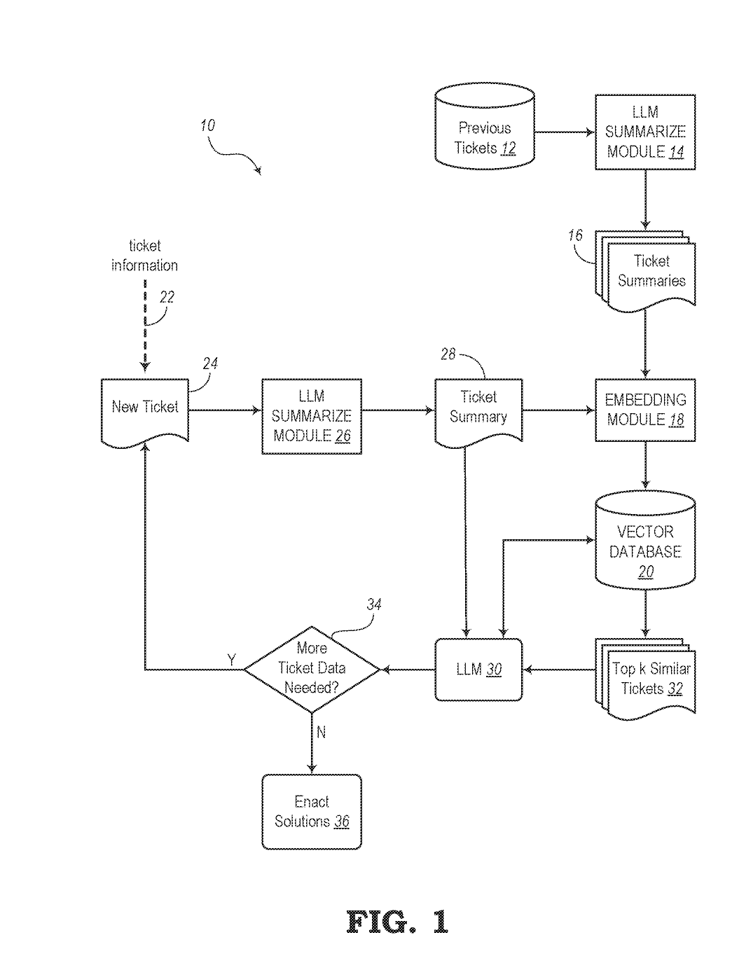

FIG. 1 is a block diagram illustrating an embodiment of a ticketing system 10 for processing customer service tickets using LLMs. As shown in FIG. 1, the ticketing system 10 includes a database 12 that stores previous tickets. For example, the previous tickets may include at least a number of tickets associated with a network domain for which issues (e.g., network issues) have already been resolved. Furthermore, the ticketing system 10 includes an LLM summarize module 14 that is configured to create “summaries” for the previous tickets resulting in ticket summaries 16. For example, summaries may include a short description of the overall issue, a time range during which the issue has occurred, monitoring and testing data of a network domain, a list of organizations, customers, and/or domain devices affected by the issue, information regarding attempts to resolve the issue, root cause analysis, and/or other data associated with the analysis of the issue and resolutions to the issue.

The ticket summaries 16 are applied to an embedding module 18 configured to convert the multi-dimensional features of each ticket summary to a multi-dimensional vector. The vectors are stored in a vector database 20, which is configured to store the multiple vectors associated with previous tickets as well as continuously add new vectors associated with new tickets to establish a rich base of multiple types of issues that may arise within a domain and how these issues may be resolved.

The ticketing system 10 further includes an entry 22 of new ticket information, which may be obtained via a User Interface (UI) of a user or customer operating on behalf of a specific domain in which an issue is detected. The entry 22 may include information associated with the customer, organization, or domain and information regarding one or more issues, questions, queries, etc. regarding the domain. In some embodiments, new tickets may be opened automatically by domain systems that continuously monitor the customer’s domain. In other embodiments, new tickets may be opened using a manual approach.

The new ticket information is used to create a new ticket 24. The ticketing system 10 also includes another LLM summarize module 26, which may be the same as or similar to the LLM summarize module 14. In this case, the LLM summarize module 26 is configured to summarize the information of the new ticket 24 to create a ticket summary 28. In addition, the ticketing system 10 includes an LLM 30 configured to receive data of the ticket summary 28 and process the ticket summary 28. One task of the LLM 30 involves the performance of a similarity search with respect to entries in the vector database 20, which may include providing the data from the ticket summary 28 to the vector database 20 and requesting the top k similar tickets 32 from the vector database 20. From the top k similar tickets 32, the LLM 30 can determine how to handle the current issue, as defined in the ticket summary 28. That is, the same or similar resolution steps taken in one or more previous tickets may also be followed with respect to the new ticket 24.

In some cases, the LLM 30 may determine that more ticket data is needed, as indicated in decision block 34. If so, the ticketing system 10 is configured to return back to an interface associated with the new ticket 24 to request additional information from the original requestor and/or obtain additional parameters from monitoring and telemetry systems associated with the customer domain of concern. In other cases, the LLM 30 may determine that a clear strategy for handling the new ticket 24 can be discovered from similar ticket resolution actions. As such, the LLM 30 may instruct applicable controllers to enact suitable solutions 36 to the domain of concern. For example, some solutions may include automatically modifying network configurations of the customer domain, rerouting or redirecting network traffic, optimizing routes, avoiding faulty nodes, restarting hardware devices and/or software applications, adding networking or processing capabilities, restoring connectivity, etc.

It may be noted that multiple LLMs can be used by the ticketing system 10. In some embodiments, multiple LLMs may be configured to operate in a cooperative manner. In other embodiments, the LLMs may operate independently of each other and/or may interact with each other according to a collaborative plan based on domain-specific policies and functionality.

The ticketing system 10 may be an automated customer support system that integrates domain-specific LLMs and embedding models tailored to a cloud security platform. One general feature of the ticketing system 10 includes “dynamic ticket summarization,” which may include automatically creating a concise summary of each support ticket upon creation. Dynamic ticket summarization may further include real-time updates for continuously updating the new ticket 24 and ticket summary 28 as new information is added. In this way, the new ticket 24 and ticket summary 28 may include comprehensive content, including summaries of domain details (e.g., issue descriptions, actions taken, findings, proposed next steps, etc.).

A second general feature of the ticketing system 10 may include “solution recommendation,” which can be based on historical data. This may include semantic analysis that uses embedding models to process ticket content semantically. Also, solution recommendation may include a similarity search that compares current tickets to historical data stored in the vector database 20. The recommendations, for instance, may suggest solutions that have been effective in resolving similar issues and/or may enact automated resolutions within the domain.

A third general feature of the ticketing system 10 may include “automated action triggering” (as indicated in block 36). The action triggering may be based on comment analysis of the information of the new ticket 24. This may include real-time monitoring to continuously monitor ticket comments for specific keywords, patterns, sentiments, etc. Predefined actions may be automatically triggered, such as requesting diagnostics, suggesting tools, and/or escalating tickets. Also, the ticketing system 10 can provide proactive support to enable timely and appropriate responses without manual intervention, increasing efficiency and customer satisfaction.

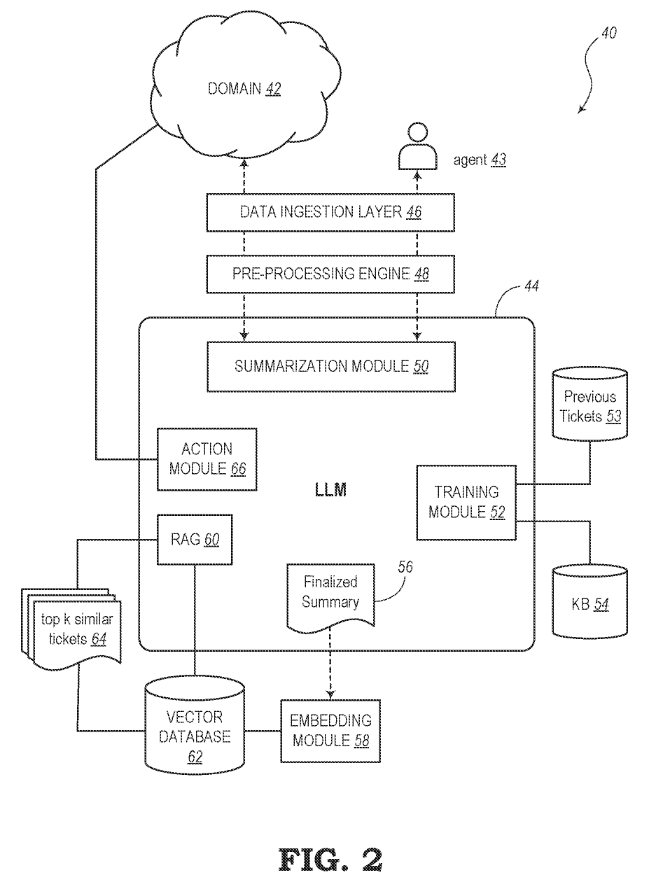

FIG. 2 is a block diagram illustrating another embodiment of a ticketing system 40 using an LLM. As shown in this embodiment, the ticketing system 40 includes a domain 42 or environment that is under observation. The domain 42 may refer to a network or organizational domain associated with a particular enterprise for which a user (e.g., network operator, technician, engineer, admin, etc.) may request the opening of a new ticket. Thus, the domain 42 may include network equipment, switches, routers, end user devices, network monitoring and telemetry systems, control systems, etc. In addition, an agent 43 associated with a cloud-based security entity may further provide manual clarifications, interpretations, input, etc. in addition to the manual or automated data and network metrics provided in the form of ticket information for requesting and defining a new ticket. The input regarding the opening of a new ticket is communicated to an LLM 44 or another cloud-based service system for handling customer service tickets.

The ticketing system 40 includes a data ingestion layer 46 and a pre-processing engine 48, which, in some instances, may be part of the LLM 44 or cloud-based ticket processing system. The data ingestion layer 46 may include Natural Language Processing (NLP) systems and devices, chatbot UIs, and other various systems for ingesting new ticket information. The pre-processing engine 48 may include NLP devices, AI models, ML models, etc. for cleaning the ticket information and putting the information into a usable format for suitable processing by the LLM 44. The data ingesting layer 46 and/or pre-processing engine 48 may be configured to pick up specific keywords, patterns, objectives, bullet points, etc.

As shown in FIG. 2, the LLM 44 may include a summarization module 50 configured to receive the ticket information and create a ticket summary of the new ticket opened for one or more specific issues within the domain 42. The LLM 44 may also include a training module 52, which may use AI or ML supervised training techniques. For example, the training module 52 may be configured to obtain data regarding previous tickets stored in a database 53 (e.g., ticket data related to resolved tickets for the domain 42) and may further obtain domain-specific details of the domain 42 as stored in a knowledge base 54. The domain-specific details may include topology information of the domain 42 and policies, standards, and protocols associated with the domain 42. The training module 52 may be configured to train the LLM 44 to enable the LLM 44 to effectively manage new tickets for the domain 42. It should be noted that the LLM 44 may be configured to be trained with respect to any number of domains to allow the processing of tickets for multiple customers or clients.

The LLM 44 may be configured to analyze the new domain-specific ticket information and create an ongoing summary that can be modified dynamically, as described with respect to FIG. 1. The LLM 4 may then produce a finalized summary 56 of the new ticket. The finalized summary 56 can be provided to an embedding module 58. Also, the LLM 44 may include a Retrieval-Augmented Generation (RAG) module 60, which may be configured to access a vector database 62 and retrieve top k similar tickets 64. Also, the embedding module 58 is configured to store vector data of multiple tickets in the vector database 62. The LLM 44 may further include an action module 66 configured to provide control signals to the domain 42 to change configuration tables, reroute transmission paths, or perform other changes to the domain 42 to reduce congestion or traffic, optimize routes, etc. As described with respect to FIG. 1, additional ticket information may be obtained from the domain 42 to modify the finalized summary 56 or an ongoing summary of the ticket.

The data ingestion layer 46 may be configured as an interface for integrating domain-specific data with the LLM 44. The data ingestion layer 46 is configured to be an interface with the LLM 44 of the ticketing system 40 using Application Programming Interfaces (APIs) to retrieve ticket data, including descriptions, comments, and updates. The pre-processing engine 48 may be configured for data cleaning to process and cleanse text data and may include secure privacy compliance in which the pre-processing engine 48 strips sensitive information to maintain compliance with data privacy regulations.

The LLM 44 may be configured as a domain-specific model for one or more domains to provide customized response based on the domain under observation. The training module 52 of the LLM 44 may be configured for customized training, where the LLM 44 can fine-tune the analysis of ticket information based on historical ticket data and domain-specific knowledge. The LLM 44 may also include cloud security proficiency and may specialize in understanding domain-specific terminology. For example, in the realm of cloud-based cybersecurity (e.g., using cloud tools), the LLM 44 may be configured to understand cloud security terminology, recognize common issues with respect to cloud security, and contextualize support requests.

The training and embedding models (e.g., embedding module 18, 58, training module 52, etc.), the ticketing systems 10, 40 may be configured with vector databases 20, 62, etc. for perform nearest neighbor and/or similarity searching to find previously discovered, tried and true solutions to current issues or tickets. The embedding modules 18, 58 may be configured for vector conversion to convert ticket content into numerical vector representations. Then, efficient searches may be conducted with respect to stored vectors in the searchable vector databases 20, 62 for efficient similarity-based solution recommendations. The LLMs may further analyze and process the recommendations as needed to fine-tune the analysis and resolution processes.

The action module 66 may be configured as an action triggering module, which may include pattern recognition using NLP techniques to analyze ticket comments for specific phrases or patterns. Automated actions may include detecting keywords and triggering predefined actions based on the content analysis.

The data ingestion layer 46 may be configured to connect to a ticketing system of a cloud security service (e.g., offered by a cloud service provider) via APIs. Also, the data ingestion layer 46 may be configured to retrieve ticket data, including descriptions, comments, and updates. The pre-processing engine 48 may be configured to clean and normalize text data and also remove sensitive information to comply with data privacy regulations.

The LLM 44 may be a domain-specific LLM configured so as to a) be fine-tuned on the domain’s historical ticket data, and b) understand cloud security terminology and common issues. The embedding model (e.g., embedding module 58) and vector database 62 may be configured so as to a) convert ticket content into numerical vectors, and b) store vectors in a database for efficient similarity searches. The action module 66 or Action Triggering Module may be configured to a) analyze ticket comments using natural language processing, and b) detect patterns and trigger predefined actions.

An operational workflow, for example, may include:
1. Dynamic Ticket Summarization – generating an initial summary at the time of ticket creation, updating the summary as additional information becomes available, and allowing support agents (e.g., agent 43) to view a concise, current summary of the ticket at any time
2. Solution Recommendation – processing ticket content into embeddings for semantic representation, conducting similarity searches within the vector database to find relevant past tickets, and recommending solutions that have been successful in resolving similar issues.
3. Automated Action Triggering – monitoring ticket comments for specific triggers, such as diagnostic requests or escalations, and automated follow-up actions based on detected keywords or phrases.

### Ticket Managing System

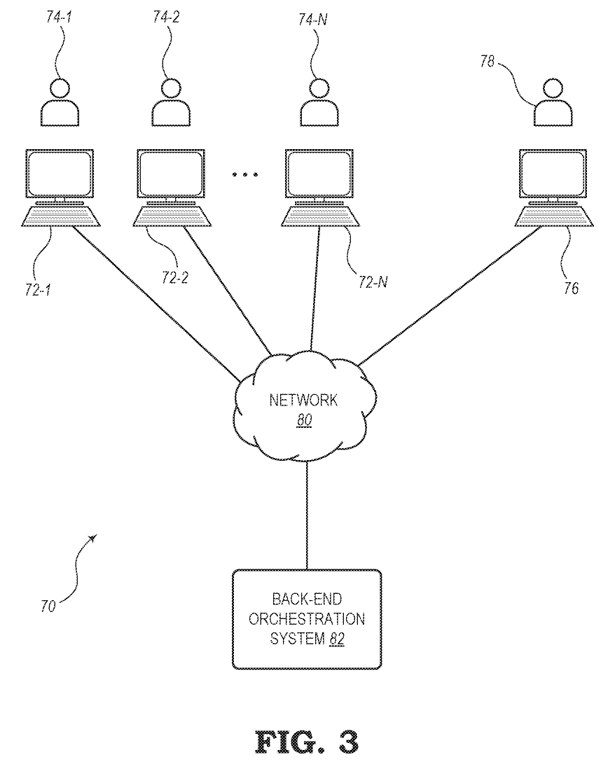

FIG. 3 is a block diagram illustrating an embodiment of a ticket managing system 70 for managing tickets and ticketing processes for an enterprise. As shown in this embodiment, the ticket managing system 70 includes a plurality of endpoint devices 72-1, 72-2, …, 72-N employed within the enterprise and used by a plurality of users 74-1, 74-2, …, 74-N. Also, the enterprise may include an IT/admin device 76 (or multiple IT/admin devices) used by one or more service desk engineers 78 (e.g., local agents, ticket managers, network operators, IT personnel, administration personnel, enterprise technicians, etc.). In some embodiments, local communication in enabled among the endpoint devices 72-1, 72-2, …, 72-N and IT/admin device 76 within the enterprise or VPN without communication over the Internet or other external network outside of the enterprise network.

In the embodiment shown in FIG. 3, the ticket managing system 70 further includes a network 80 (e.g., Internet) and a back-end orchestration system 82. The back-end orchestration system 82 may be configured to provide ticketing services to one or more enterprises in the cloud. The back-end orchestration system 82 can orchestrate various ticketing functions with respect to each individual enterprise and isolate each enterprise accordingly in a secure manner. In some embodiments, the back-end orchestration system 82 may include digital experience monitoring services and/or may be part of a larger system (e.g., cloud-based server) that offers digital experience monitoring services. Also, the back-end orchestration system 82 may include and/or be part of a larger system that monitors user access to various software within the enterprise network and remote cloud network.

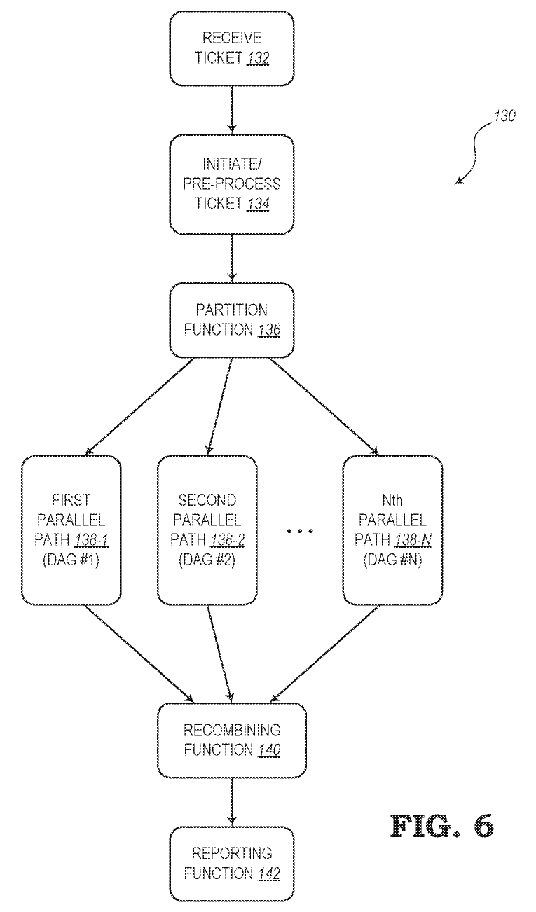

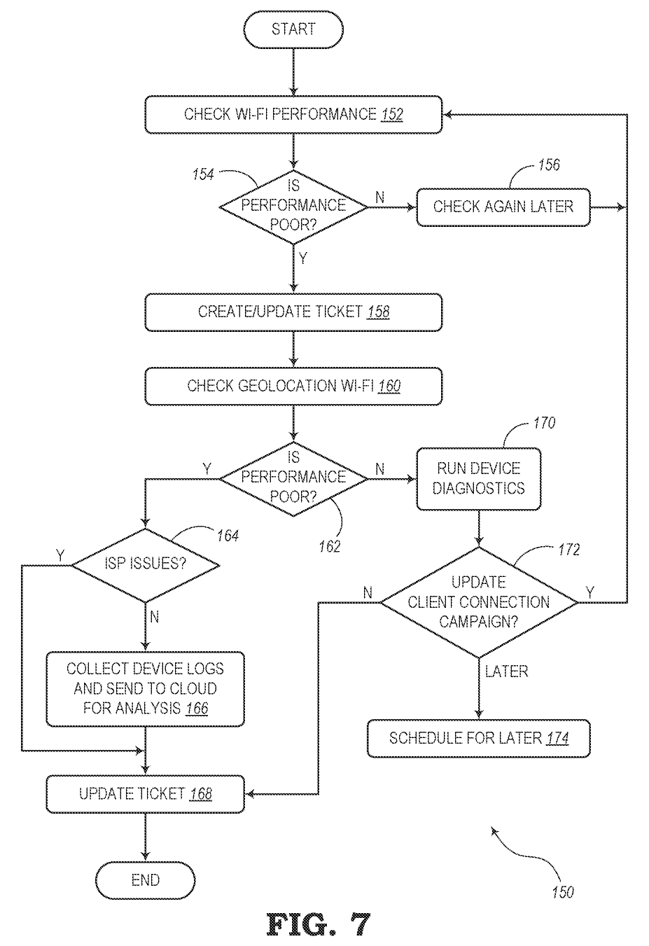

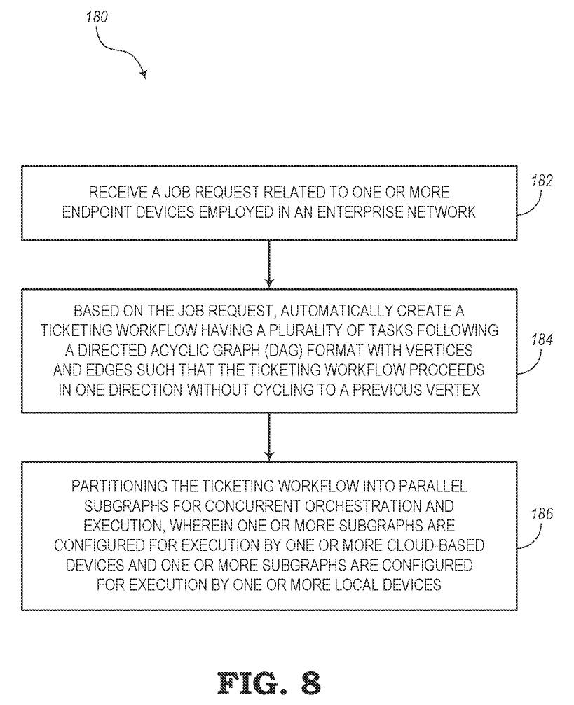

According to some embodiments, the back-end orchestration system 82 may be configured to provide at least two main services:1) creating a customized workflow for handling tickets within an enterprise and 2) coordinating remote operations (e.g., upgrade software) on a plurality of endpoint devices (e.g., endpoint devices 72-1, 72-2, …, 72-N) of an enterprise based on telemetry information. In some embodiments, FIGS. 6 and 7 (described below) are related to the first service of creating a customized workflow, and FIG. 8 (described below) is related to the second service of coordinating remote operations on endpoint devices.

Generally, the first service of creating a customized workflow may include the automated designing of a Directed Acyclic Graph (DAG), an example of which is shown in FIG. 6. For example, a DAG, in graph theory, is a directed graph with no directed cycles. That is, it consists of vertices and edges (or arcs), with each edge directed from one vertex to another, without forming a closed loop. A DAG is topologically ordered by arranging the vertices as a linear ordering that is consistent with all edge directions. In the case of a directed graph, each edge has an orientation, from one vertex to another vertex. A path in a directed graph is a sequence of edges having the property that the ending vertex of each edge in the sequence is the same as the starting vertex of the next edge in the sequence.

Thus, a DAG is “directed,” whereby edges between vertices (nodes) have a direction going from one vertex to another in a specific way. The DAG is “acyclic,” whereby paths do not have cycles that eventually loops back to the same vertex. In some cases, the DAG may also be referred to as a flowchart, dependency graph, topologically ordered graph, workflow graph, or other name.

The back-end orchestration system 82 may be configured to create the DAG by 1) defining a set of vertices (or nodes), 2) connecting vertices with directed edges while ensuring no cycles form, and 3) using algorithms like topological sorting to maintain the acyclic property. After creation, the DAG can then be used for data processing frameworks to define dependencies between computations. The DAG can also be used as a version control systems (e.g., Git) where commits form a DAG structure. With respect to the present disclosure, the DAG may be constructed for the purpose of scheduling ticketing tasks of a ticketing operation, where the DAG can be included in software, such as in an operating system and compiler, for scheduling instructions in a CPU.

Basically, a DAG is a graph (or flowchart) having arrows indicating a sequence of steps or functions whereby the flow of steps proceeds in one direction and does not loop back (i.e., acyclic). The DAG or one-directional flowchart may include multiple parallel paths to enable concurrent processing on different components. In the present disclosure, the DAG is configured for automating a workflow for managing tickets or service requests with respect to an enterprise network and/or the devices operating in the enterprise network.

Another feature of the DAGs described in the present disclosure is that they may have a “holistic” nature. In other words, instead of merely focusing on one single thing, such as data security, identity verification, malware detection, etc., the systems and methods of the present disclosure are configured to create a workflow having a holistic approach that accounts for multiple different aspects of the enterprise. In particular, creating parallel DAG paths allows processing on the local level (e.g., by the endpoint devices 72 and/or IT/admin device 76 of the enterprise) and processing on a remote level (e.g., by the cloud-based back-end orchestration system 82). The automated construction of the DAG includes partitioning (or splitting) the various tasks into locally processed tasks and remotely processed tasks.

In addition to this first main service of creating a DAG workflow, the systems and methods of the present disclosure are further configured to perform the second main service of coordinating or orchestrating remote operations on a plurality of endpoint devices of an enterprise. For example, these remote operations may include the rolling out of new software application to a group of endpoint devices, coordinating mas upgrades of software or firmware on these endpoint devices, etc.

For example, with respect to rolling out a software update, the back-end orchestrating system 82 may be configured to perform the upgrade in batches instead of performing the upgrade all at once. The value of rolling out in stages (i.e., one batch of endpoint devices at a time) is that a first “trial batch” (e.g., canary batch) can be monitored to determine how these devices react to the new upgrade. Again, with the holistic approach mentioned above, there may be many unforeseen complications regarding interactions within an enterprise. Thus, by limiting an initial stage to a small number of devices, the impact on the entire fleet of devices can be minimized or limited to a reasonable extent. If issues are discovered, the back-end orchestration system 82 may be configured to back out of the changes (e.g., reverse or undo the changes). When any issues are resolved with the trial batch, the upgrade process can resume (e.g., batch by batch) until the entire intended group of devices is upgraded according to plan.

The remote operations performed by the back-end orchestration system 82 may include at least one or more of the following: a) software updates, fixes, etc. at the most opportune time, b) software or firmware updates, fixes, etc. in batches with the ability to back out as needed, etc.

### Computing System of a Back-End Orchestrator

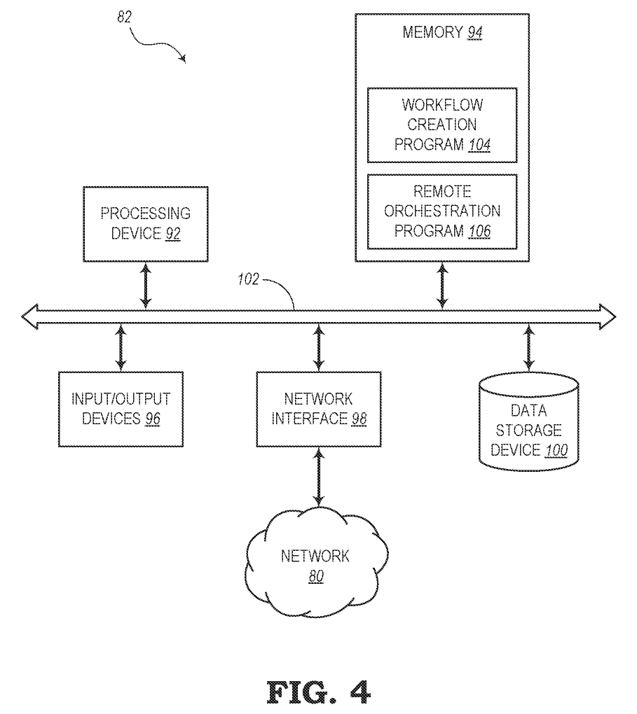

FIG. 4 is a block diagram illustrating an embodiment of a computer system 90 of the back-end orchestration system 82 shown in FIG. 3 or any suitable remote ticket managing server. As shown in its simplified form, the computer system 90 includes a processing device 92, memory 94, Input/Output (I/O) devices 96, a network interface 98, and a data storage device 100 (or database), interconnected with each other via a local interface 102 (or bus).

The processing device 92 may include one or more processors or microprocessors, such as a Central Processing Unit (CPU), which is configured to execute instructions and process data. The processing device 92 may be a general-purpose processor, a special-purpose processor, an Application-Specific Integrated Circuit (ASIC), or any combination thereof. The processing device 92 is configured to perform various computational tasks and manage the operations of the computer system 90, including executing software instructions stored in the memory 94. In some embodiments, the processing device 92 may also include or be coupled with a Graphics Processing Unit (GPU), a Digital Signal Processor (DSP), or other specialized processing units that assist in performing specific functions such as image processing, machine learning, or data analysis. The processing device 92 may operate in conjunction with other components of the computer system 90, communicating via the local interface 102.

The memory 94 in the computer system 90 may include any combination of volatile and non-volatile memory components, such as Random-Access Memory (RAM), Read-Only Memory (ROM), flash memory, and other forms of computer-readable storage media. The memory 94 is configured to store software programs, applications, and data that are executed or processed by the processing device 92. The memory 94 may also store an Operating System (O/S) and/or operating instructions that manage the overall operation of the computer system 90. In some embodiments, the memory 94 may be further subdivided into different types, such as main memory (e.g., dynamic RAM) for temporary storage of active data, and secondary memory (e.g., non-volatile memory) for storing data persistently even when the system is powered down. The memory 94 may be dynamically allocated by the computer system 90, and it may be accessible by the processing device 92 and other components via the local interface 102.

The I/O devices 96 allow the computer system 90 to interact with a user, the external environment, and other systems. Input devices may include, but are not limited to, keyboards, mice, touchscreens, microphones, and other sensors or control devices that enable the user to input commands or data into the system. Output devices may include displays, printers, speakers, or haptic feedback devices that allow the computer system 90 to convey information or feedback to the user or external systems. In some embodiments, the I/O devices 96 may also include peripheral devices such as cameras, scanners, or biometric sensors. These I/O devices 96 may be directly connected to the computer system 90 or may communicate with the computer system 90 wirelessly, such as via the network interface 98.

The network interface 98 facilitates communication between the computer system 90 and external networks, such as network 80, a local area network (LAN), a wide area network (WAN), or the Internet. The network interface 98 may include both wired and wireless communication capabilities, such as Ethernet, Wi-Fi, Bluetooth, or other protocols. The network interface 98 enables the computer system 90 to transmit and receive data, connect to remote servers, or access cloud-based services. In some embodiments, the network interface 98 may be integrated with other components of the computer system 90 or implemented as a separate hardware module, and it may support various network protocols, including Transmission Control Protocol/Internet Protocol (TCP/IP), User Datagram Protocol (UDP), and others. The network interface 98 may also provide security features such as encryption, firewalls, and authentication mechanisms to ensure secure communication.

The data storage device 100 is configured to store data persistently, which may include structured data, unstructured data, program files, system logs, and other forms of digital information. The data storage device 100 may take various forms, such as a Hard Disk Drive (HDD), Solid-State Drive (SSD), or other non-volatile memory technologies. In some embodiments, the data storage device 100 is organized as a database, storing records, tables, and indexes that facilitate the efficient retrieval, updating, and management of data. The data storage device 100 may include multiple components and may be local to the computer system 90 and/or connected via a network to external storage resources, such as cloud-based storage platforms. The processing device 92 may interact with the data storage device 100 to retrieve and store data required for executing software applications, maintaining system logs, or providing data for analytical processes.

The various hardware components of the computer system 90, including the processing device 92, memory 94, I/O devices 96, network interface 98, and data storage device 100, communicate with each other over the local interface 102. This local interface 102 may be implemented as a bus, such as a system bus, memory bus, or input/output bus, which provides a communication pathway between the different components. The bus may be based on any standard bus architecture, including but not limited to Peripheral Component Interconnect (PCI), Universal Serial Bus (USB), or Advanced Microcontroller Bus Architecture (AMBA). In some embodiments, the local interface 102 may include multiple buses or communication channels that handle different types of data traffic, such as high-speed data transfers between the memory 94 and the processing device 92, or lower-speed communication with the I/O devices 96 or peripheral devices. The local interface 102 allows for the efficient exchange of data between components and ensures synchronized operation of the system.

In addition, the computer system 90 includes a workflow creation program 104, a remote orchestration program 106, and/or other suitable ticket managing programs. The programs 104 and 106 may be implemented in any suitable combination of hardware (e.g., in the processing device 92) or software/firmware (e.g., in the memory 94). The programs 104 and 106 may be stored in non-transitory computer-readable media (e.g., memory 94) and may include logic code having instructions that, when executed, enable or cause the processing device 92 (or one or more processors) to perform certain ticket management functions as described in the present disclosure.

### Workflow Creation

In conventional systems, complex IT workflows may often span multiple systems (both internal and external), such as ServiceNow, Jira, Mobile Device Manager (MDM) tools, log collectors, sentiment analysis services, etc. According to traditional operation, service desk agents may routinely orchestrate these tasks in a sequence, creating tickets, collecting logs, running analysis, and so on. Historically, these processes have been manual, time-consuming, and distributed across separate tool chains.

However, the systems and methods of the present disclosure are configured to improve upon the conventional systems. The present disclosure is configured to provide improvements, such as reducing the overall execution time to process tickets, automating many tasks to thereby reduce manual efforts, etc. The systems and methods described herein are configured as a next-generation workflow engine that can represent these tasks as a DAG and intelligently partitions its execution between the cloud and end-user devices. By automatically dividing the DAG into parallelizable subgraphs, the present systems and methods can significantly reduce overall execution time and manual effort.

Again, conventional systems may include Complex Task Sequences. That is, service desk agents may be required to juggle multiple systems (e.g., ServiceNow or Jira for IT tickets, remote script execution, intelligent log analysis, and MDM-based software installations, etc.). Also, conventional systems usually require Multiple Touchpoints in which separate tickets or manual interventions would be needed for each step, leading to increased overhead and potential errors. Furthermore, conventional system may use Inefficient Orchestration methods, whereby, without an intelligent system to parallelize or partition tasks, most of the conventional workflows would be executed sequentially, causing delays.

Therefore, the systems and methods described in the present disclosure are configured to overcome these issues with the conventional systems. One aspect of the present disclosure is the inclusion of a cloud-based workflow engine (e.g., back-end orchestration system 82) configured to create a customized workflow to handle tickets as well as performing a remote orchestration procedure for performing operations on devices within an enterprise.

The workflow creation program 104 of the computer system 90 is configured to enable the back-end orchestration system 82 to:
1) Build a Workflow DAG – In some embodiments, the back-end orchestration system 82 may use Natural Language Processing (NLP) to interpret instructions (e.g., from the service desk engineer 78) regarding the handling of tickets. Also, the workflow creation program 104 may be configured to use AI or ML to orchestrate tasks in a flow in a manner that accommodates the needs as included in the instructions. Therefore, the workflow creation program 104 may be configured to create tasks of the workflow DAG without the user (e.g., service desk engineer 78) necessarily having knowledge of computer languages or code. The workflow creation program 104 collects and generates tasks in the flow to form the DAG.
2) Automatically Partition the DAG – the back-end orchestration system 82 is configured to identify which tasks should run on the endpoint devices 72 (e.g., local script execution, log collection, etc.) versus which tasks are better suited for the back-end orchestration system 82 in the cloud (e.g., creating a ticket in Jira, running analytics, etc.). The tasks can then be grouped into parallel subgraphs for optimized execution. In some embodiments, two parallel subgraphs may be created (e.g., one for the endpoint device 72 or IT/admin device 76 requesting a ticket and one for the back-end orchestration system 82). In other embodiment, more than two paths may be generated for additional parallelization.
3) Distributed Execution – having partitioned or split the tasks into relatively equal paths, the tasks in each subgraph or DAG section can be performed. In the cloud, the back-end orchestration system 82 is configured to orchestrate external integrations (e.g., Jira, ServiceNow, MDM APIs, sentiment analysis, etc.) and consolidate overall workflow results. In the enterprise, the endpoint device 72 (and/or IT/admin device 76) is configured to execute scripts locally, collects logs, or performs any on-device action, reporting outcomes or results back to the cloud.
4) Unified View and Control – the service desk engineer 78 is able to use the IT/admin device 76 to see results on a UI or dashboard in order to track progress from a single viewpoint, for each individual ticket. In some embodiments, the tracking of progress of tickets may be monitored by remote agents associated with the back-end orchestration system 82, if such additional service is needed (e.g., for enterprises with a smaller staff or limited IT/admin personnel). Once the workflow DAG completes, the back-end orchestration system 82 is configured to aggregate the results into a final report, which can be displayed on a suitable display device or UI.

Some benefits of the workflow DAG creation, as described in the present disclosure, include:
1) Increased Productivity – the procedures may include One-Click Automation, whereby the service desk engineer can create a single, automated workflow rather than multiple, manually managed tasks. Also, with Parallel Execution, the partitioning of tasks enables concurrent processing, speeding up resolution times.
2) Reduced Manual Work – with Single Tracking Ticket, the procedures can eliminate the need to chain multiple tickets in disparate systems. All sub-tasks may be configured to roll up into a single workflow ticket. Also, with Flexible Scheduling, the systems and methods can trigger workflows automatically based on events (e.g., device health issue) or on a set schedule.
3) Workflow Creation with No Coding Skills Needed – the systems and methods can use AI-assisted processes (e.g., Copilot), whereby users can create or modify workflows using natural language prompts. Also, the prompt fields may include Drag-and-Drop functionality, where a simple interface can ensure even non-technical users can provide input to allow the back-end orchestration system 82 to build complex orchestrations.
4) End-to-End Control and Security – In some embodiments, the systems may include Single-Vendor Coverage. Unlike conventional systems that integrate with external tools for areas like network or data security, the systems and methods of the present disclosure are configured to leverage a single solution set if needed. Also, with Partitioning Heuristics, the back-end orchestration system 82 may be configured to make intelligent decisions on which tasks stay local and which tasks go to the cloud, thereby optimizing both security and performance.

Thus, the systems and methods of the present disclosure may use a Holistic Platform. Conventional systems may focus only on digital employee experience or require external integrations, the present disclosure offers broad coverage across network security, data security, MDM, and more. Also, with Workflow Partitioning, the intelligent splitting of the DAG into cloud and endpoint segments is unique with respect to conventional systems and is configured to ensure optimized performance as an improvement over conventional systems. Furthermore, No-Code + AI Assistance entry of ticketing information allows for a simpler interface for users (e.g., service desk engineer 78, agents, etc.). By leveraging natural language interfaces or “copilot” functionality, creating or customizing workflows becomes far simpler than traditional orchestration tools.

Thus, the workflow creation program 104 enables the back-end orchestration system 82 to offer Intelligent No-Code Workflow Creation & Scheduling. This allows users 74 and/or service desk engineers 78 to easily define triggers or schedules, and the system can then automatically generate the DAG. Also, the workflow creation program 104 provides Seamless Orchestration Across Multiple Products & Integrations. The back-end orchestration system 82 (or ticketing engine) can integrate with both in-house and third-party services (e.g., ServiceNow, Jira, MDM tools) without extra manual glue. Furthermore, the workflow creation program 104 enables Optimization Through Intelligent Partitioning. That is, the back-end orchestration system 82 can automatically split tasks into subgraphs that execute locally or in the cloud based on performance, security, or resource constraints.

### Coordination of Remotely Managed Enterprise Operations

In conventional systems, IT operations require precise control over remote actions (e.g., script executions, surveys, device updates, etc.). However, they may not be able to completely avoid disrupting end-user productivity for mitigating widespread issues from unforeseen bugs. On the other hand, the systems and methods of the present disclosure provide innovative solutions to overcome the shortcomings of these conventional systems. The back-end orchestration system 82 may be referred to, in some cases, as an Intelligent Remote Action Orchestrator (IRAO) and may be configured to dynamically schedule remote tasks by leveraging real-time telemetry, advanced machine learning models, and context-aware data integration to determine the optimal timing for each action. The remote orchestration program 106 may be configured to enable these functions for the devices on an enterprise network.

For example, the remote orchestration program 106 enables the back-end orchestration system 82 to perform:
1) Context-Aware Scheduling – This may include Real-Time Telemetry by continuously collecting granular data from the endpoint devices 72. For example, the collected telemetry data may include device health metrics, network conditions, active application status, and even calendar integration (e.g., detecting if the user 74 is in a meeting or otherwise detained). Context-aware scheduling may also include Data Fusion with existing enterprise software configured to monitor user access, provide network security (e.g., zero trust security) for the enterprise, monitoring digital experience metrics, etc. Also, by integrating with an observability platform (e.g., logs), the system is configured to gain a detailed view of user behavior and security posture, enabling highly informed decision-making.
2) Adaptive Canary Deployment – with Iterative Rollouts, remote actions may be initially deployed on a small, strategically selected subset of devices (e.g., canary group, trial group, etc.) based on a multi-criteria decision engine. Also, this may include a Feedback Loop & Autonomous Adjustments, whereby performance metrics and anomaly detection algorithms may be continuously monitored with respect to the canary group. If metrics remain within acceptable, suitable, or safe thresholds, the rollout is progressively expanded to one or more additional groups in turn. Conversely, any deviations may trigger immediate halts and automated rollbacks, ensuring minimal impact.
3) Predictive Scheduling with Machine Learning (ML) – the remote orchestration may include an Intelligent Window Prediction, which may include leveraging historical data and real-time inputs. ML models may be configured to forecast optimal execution windows when endpoint devices 72 are idle and/or when user productivity will be least affected. This may also include Dynamic Prioritization, where the system can automatically reprioritize tasks based on evolving conditions of the endpoint devices 72 and user activity, ensuring that high-priority actions are executed in the most favorable conditions.
4) Event-Driven Architecture – remote orchestration may use Microservices and Stream Processing by utilizing suitable frameworks (e.g., Apache Kafka) for data streaming. Also, the remote orchestration can ensure that decisions are made in near real-time. This event-driven architecture enables rapid responses to sudden changes in endpoint status or network conditions.

As such, the benefits of using the remote orchestration program 106, as opposed to conventional systems, is that the present systems and methods can provide:
1) Minimized User Disruption: By scheduling remote actions during low-impact periods, the system ensures that critical user tasks remain uninterrupted, enhancing overall satisfaction.
2) Risk Containment: The canary deployment strategy confines potential issues to a small subset of devices, significantly reducing the risk of widespread failure.
3) Fully Automated and Scalable: Once triggered by a service desk operator, the process is entirely autonomous, reducing manual intervention and scaling effortlessly across large networks.
4) Enhanced Observability and Security: Integration with existing security solutions (e.g., Zscaler products) not only improves scheduling precision but also reinforces the organization’s overall security posture.

Thus, the back-end orchestration system 82 can provide orchestration of operations on a remote group of components. This may include Smart Triggering, whereby remote actions are triggered based on a composite analysis of device health, user activity, contextual signals, etc. This can ensure that tasks are executed only when conditions are optimal. Furthermore, the orchestration can include Automated Canary Rollouts, whereby the system can deploy actions incrementally, monitoring outcomes with a feedback loop that can autonomously adjust the rollout strategy or initiate rollbacks, as necessary. Also, orchestration may include Predictive and Adaptive Scheduling, whereby ML models can predict the best execution windows, dynamically adapting to real-time endpoint conditions and past performance data.

### Computing System of a Local Service Desk Device

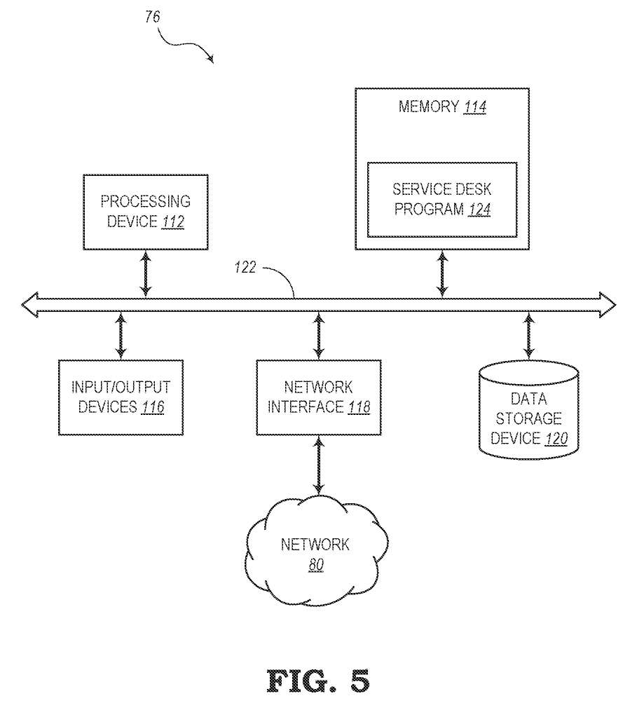

FIG. 5 is a block diagram illustrating an embodiment of a computer system 110 of the IT/admin device 76 shown in FIG. 3. In some embodiments, the computer system 110 may also represent one or more of the endpoint devices 72-1, 72-2, …, 72-N shown in FIG. 3. As shown in its simplified form, the computer system 110 includes a processing device 112, memory 114, Input/Output (I/O) devices 116, a network interface 118, and a data storage device 120 (or database), interconnected with each other via a local interface 122 (or bus). The components 112, 114, 116, 118, 120 may be configured as described above with respect to the computer system 90 of FIG. 4.

In addition, the computer system 110 includes a service desk program 124, which may be implemented in any suitable combination of hardware (e.g., in the processing device 112) or software/firmware (e.g., in the memory 114). The service desk program 124 may be stored in non-transitory computer-readable media (e.g., memory 114) and may include logic code having instructions that, when executed, enable or cause the processing device 112 to perform certain ticket management functions as described in the present disclosure. For example, the service desk program 124 may work in conjunction with the workflow creation program 104 and remote orchestration program 106 to enable local management as needed. In some cases, a user (e.g., service desk engineer) working at an enterprise may be responsible for pre-processing tickets from within the enterprise before the tickets are submitted to cloud-based services. Also, the service desk engineer can use the service desk program 124 to enter locally obtained data, as needed, initiate remediation actions, and/or schedule service upgrades.

### Ticket Workflows with Directed Acyclic Graph DAG

FIG. 6 is a diagram illustrating an embodiment of a ticket processing workflow 130 having a Directed Acyclic Graph (DAG). In the DAG format, the ticket processing workflow includes 1) a plurality of vertices (or nodes) represented by reference numerals in the FIGS. and 2) a plurality of directional edges connecting the vertices, whereby the edges are represented in the figures as arrows. In some embodiments, the ticket processing workflow 130 may be a DAG generated by the workflow creation program 104 shown in FIG. 4. As shown in this example, the ticket processing workflow 130 includes a first function of receiving a ticket, as indicated in vertex 132 (or node). Next, the ticket processing workflow 130 includes initiating and/or pre-processing the ticket, as indicated in vertex 134. The next step in the ticket processing workflow 130 includes partitioning the workflow into multiple parallel paths, as indicated in vertex 136, wherein processing may occur concurrently by one or more devices, processors, computers, etc.

In this example, the multiple parallel paths may include a first parallel path 138-1 (e.g., DAG #1), a second parallel path 138-2 (e.g., DAG #2), …, and an Nth parallel path 138-N (e.g., DAG #N). Each of the paths 138 may include multiple vertices (e.g., with directional and acyclic edges) to proceed from the vertex 136 regarding the partition function onward. In some embodiments, there may be two parallel paths, whereby one path is a local path for execution by an enterprise device (e.g., endpoint device 72 or IT/admin device 76) and one path is a remote path for execution by remote server device (e.g., back-end orchestration system 82). According to additional embodiments, there may be more than two parallel paths 138. For example, a multiple path implementation may utilize one or more endpoint device 72, the IT/admin device 76, and one or more cloud-based ticketing service orchestrators. Local operations of the ticket processing workflow 130 may be partitioned to local enterprise devices while operations that are better suited for cloud-based servers may be partitioned to remote ticketing orchestration devices.

Next, the ticket processing workflow 130 includes a plurality of edges at the ends of the paths 138 for obtaining the multiple DAG paths. The ticket processing workflow 130 performs a recombining function, as indicated in the vertex 140. In some embodiments, the recombining function may include securely transmitting results from the local processing devices to the back-end orchestration system 82 for remote management of the ticket, depending on the various implementations. In other embodiments, the recombining function may include securely transmitting results from the back-end orchestration system 82 to the IT/admin device 76 for local management of the ticket, depending on the various implementations. The next vertex in the ticket processing workflow 130 includes a reporting function, as indicated in the vertex 142, whereby the results may be displayed on a suitable display device, UI, GUI, dashboard, etc. on the respective service desk device.

According to one example use case, suppose users 74 in an enterprise often experience persistent Wi-Fi issues. To streamline the troubleshooting process, the service desk engineer 78 (or other local agent) can create a workflow that methodically addresses these problems step by step, eliminating the need for manual follow-ups.

FIG. 7 shows an example of a ticketing workflow 150 that is created to address the Wi-Fi issues experienced by users 74 within the enterprise. As shown in this example, the ticketing workflow 150, when started, includes a vertex 152 regarding a task of checking Wi-Fi performance and then a vertex 154 of detecting if the performance is poor. If it is determined that the performance is fine (not poor), then the ticketing workflow 150 is configured to branch to vertex 156 regarding checking the Wi-Fi performance again later.

If the performance is found to be poor, the ticketing workflow 150 includes a vertex 158 of creating or updating a ticket. Next, the ticketing workflow 150 includes a vertex 160 regarding checking geolocation Wi-Fi conditions. A next vertex 162 includes analyzing to determine if the geolocation Wi-Fi has poor performance. If so, the ticketing workflow 150 branches to vertex 164, which includes determining if there are any ISP issues. If not, the branch (e.g., DAG path) goes to vertex 166 that includes collecting device logs and sending them to the cloud (e.g., remote ticketing server) for analysis. The ticket is then updated, as indicated in vertex 168. If there are no ISP issues detected in vertex 164, then vertex 166 is skipped and the vertex 168 regarding updating the ticket is executed.

Alternatively, if there are no geolocation Wi-Fi performance issues detected in vertex 162, then the ticketing workflow 150 includes proceeding to vertex 170, which includes running device diagnostics. Then, the ticketing workflow 150 includes a vertex 172 to determine whether to update a client connection campaign. If such an update is requested, the ticketing workflow 150 includes returning back to vertex 152. If such an update is not requested, the ticketing workflow 150 goes to vertex 168 to update the ticket and the process ends. A third option at vertex 172 is a request to update later, whereby the ticketing workflow 150 proceeds to vertex 174, which includes scheduling the update for later.

Other examples, in addition to the example shown in FIG. 7, may be created, depending on various criteria, network conditions, device conditions, needs, requests, etc. Another example may include an IT administrator initiating a security patch rollout across a global enterprise. The back-end orchestration system 82 (or IRAO) may be configured to begin by analyzing the real-time state of each endpoint device 72. This may include ensuring that these devices are online and that the corresponding users 74 are not engaged in high-priority meetings (e.g., based on calendar information or online activity). Also, this may include operating the ticketing workflow within optimal performance parameters.

With respect to deploying new software, updating software/firmware, providing a software path, etc., the ticketing workflow may be configured to test out any changes on a small trial group (e.g., canary group). The back-end orchestration system 82 may select the trial group based on certain predetermined criteria and then the change (e.g., patch) may be enacted or deployed. The workflow may include the capturing of real-time feedback (on a local scale) through integrated telemetry and security insights. If the trial/canary group exhibits stable performance, the back-end orchestration system 82 can gradually expand the enactment/deployment across the enterprise network. Should any anomalies occur, the system immediately halts further distribution and rolls back the update on affected devices, while adjusting its predictive models to better schedule future actions.

### Ticket Workflow Generation Method

FIG. 8 is a flow diagram illustrating an embodiment of a method 180 for creating a ticket workflow. As shown in FIG. 8, the method 180 includes a step of receiving a job request related to one or more endpoint devices employed in an enterprise network, as indicated in block 182. Based on the job request, the method 180 further includes a step of automatically creating a ticketing workflow having a plurality of tasks following a Directed Acyclic Graph (DAG) format with vertices and edges such that the ticketing workflow proceeds in one direction without cycling to a previous vertex, as indicated in block 184. Also, the method 180 includes a step of partitioning the ticketing workflow into parallel subgraphs for concurrent orchestration and execution, as indicated in block 186, wherein one or more subgraphs are configured for execution by one or more cloud-based devices and one or more subgraphs are configured for execution by one or more local devices.

According to additional embodiments, the one or more local devices, for example, may include an IT/admin device and the one or more endpoint devices. In some embodiments, the method 180 may include a step of receiving input from a service desk engineer for managing the ticketing workflow. The one or more cloud-based devices, for example, may include a back-end orchestration system for execution of a subgraph of the ticketing workflow. The step of receiving the job request (block 182) may include using a Natural Language Processing (NLP) API to obtain ticket information regarding tasks to be completed, scheduling, threshold analysis, and conditional actions for creating the ticketing workflow. In some embodiments, the ticketing workflow may include a vertex for consolidating results from the parallel subgraphs in order to provide a final report. Also, the method 180 may further include a step of displaying the results on a dashboard or User Interface (UI) to allow a service desk engineer to track aspects and progress of the ticketing workflow.

Furthermore, the method 180 may include steps of a) monitoring multiple applications running in the enterprise network, b) incorporating tasks of the multiple applications into the ticketing workflow using a holistic approach, and c) scheduling the tasks in subgraphs. For example, the multiple applications may be related to services or products including a) network performance analysis, b) network security management, c) data security management, d) identity verification, e) malware detection, f) device/system/network health analysis, g) mobile device management, h) log collection tools, i) sentiment analysis services, j) remote script execution tools, and/or k) intelligent log analysis tools. Also, the multiple applications may include in-house and/or third-party services and products.

In some implementations, a plurality of the tasks of the ticketing workflow may be automated. Also, the method 180 may further include a step of reusing the ticketing workflow within the enterprise network on a periodic basis to troubleshoot persistent issues. The step of partitioning (block 186), for example, may include analyzing one or more of a) available resources arranged locally and in the cloud, b) tasks to be performed, c) security constraints of different resources, d) which resources are best suited for performing the tasks, and e) time characteristics of the tasks and resources to optimize speed, in order to intelligently optimize the partitioning with respect to time, efficiency, security, and accuracy.

Therefore, a key implementation of the present disclosure may include a workflow engine aimed at automating and optimizing service desk operations by leveraging a graph-based system (DAG). It can integrate data from tools such as Jira and ServiceNow, as well as observability products (e.g., Zscaler’s ZDX product). The solutions discussed herein may be configured to automate repetitive manual tasks for service desk engineers, reducing workload and increasing efficiency.

Some aspects of the systems and methods of the present disclosure include:
1. Graph-based Structure, whereby nodes (vertices) represent tasks and subtasks, while edges represent connections or transitions based on system outputs. This may be configured to support configurable workflows that system administrators can tailor to their organizational needs (e.g., for diagnosing network or hardware issues).
2. Integration with External and Internal Tools, which may be configured to connect with external systems like Jira and ServiceNow for ticketing data. Also, these can utilize observability tools for internal data (e.g., ZDX logs, tunnel statuses, device events, etc.).
3. Automation and Decision-Making, which may be configured to build intelligence into the workflow to automatically decide next steps based on the outcome of tasks. For example, if Task 1 produces Output A, then proceed to Task 2. If Output B, then move to Task 3. Both cloud-based processing and local device processing (e.g., via ZDX agents) may be configured for utilization in parallel executions, thus accelerating resolution time.
4. Holistic Product Perspective - Unlike conventional systems that might focus on specific areas (e.g., device health, network security, etc.), the embodiments of the present disclosure are configured to offer cross-product automation covering multiple domains (e.g., data security, network issues, user experience, etc.).

Some benefits of the systems and methods of the present disclosure with respect to conventional systems may include at least:
1) Improved Resolution Times, where automated workflows can lead to faster ticket resolution.
2) Reduced Manual Intervention, since service desk engineers do not necessarily need to manually perform tasks or track outputs.
3) Cross-Product Capability, where support of various security and monitoring products may be configured to set themselves apart from competitors.

### Remote Orchestration of Ticket Operations

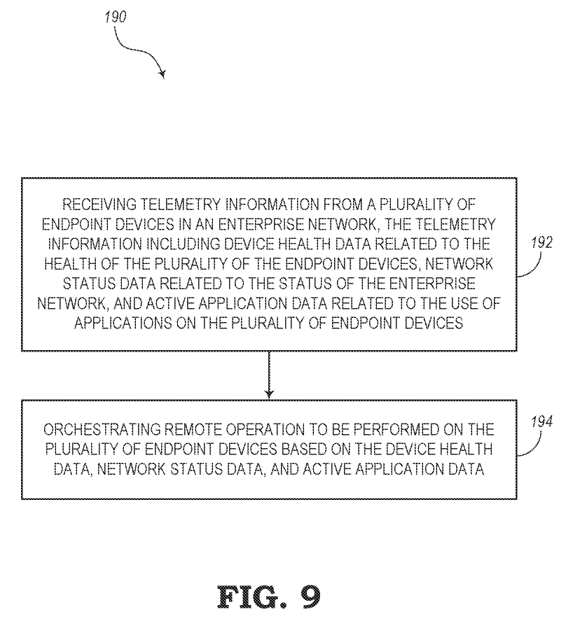

FIG. 9 is a flow diagram illustrating an embodiment of a method 190 for performing a remote orchestration procedure. As illustrated, the method 190 includes a step of receiving telemetry information from a plurality of endpoint devices in an enterprise network, as indicated in block 192, wherein the telemetry information includes device health data related to the health of the plurality of endpoint devices, network status data related to the status of the enterprise network, and active application data related to the use of applications on the plurality of endpoint devices. In addition, the method 190 includes a step of orchestrating remote operations to be performed on the plurality of endpoint devices based on the device health data, network status data, and active application data, as indicated in block 194.

In some embodiments, the remote operations may be related to a roll-out procedure for rolling out a) new software, b) a software or firmware update, and/or c) a software fix or patch with respect to one or more software applications on each of the plurality of endpoint devices. The roll-out procedure, for example, may be performed in groups of endpoint devices, wherein a first group is a trial group configured to send feedback with respect to the success of the roll-out procedure. In response to receiving feedback from the trial group that the roll-out procedure results in performance metrics within acceptable thresholds, the method 190 may further include a step of progressively expanding the roll-out procedure to continue to the next group. In response to receiving feedback from the trial group that the roll-out procedure results in performance metrics outside of acceptable thresholds, the method 190 may further include steps of 1) halting the roll-out procedure and 2) rolling back changes of the roll-out procedure.

According to some implementations, the telemetry information may be real-time telemetry information that further includes calendar data that is related to scheduled activities of a plurality of users of the plurality of endpoint devices. In some embodiments, the step of orchestrating may include scheduling the remote operations to avoid disruptions a) that would negatively affect productivity of the plurality of users, b) based on the calendar information, c) based on trends regarding hours when the plurality of users are active and inactive, and/or d) based on information regarding low-impact working time periods.

The step of orchestrating (block 194), for example, may include predictive scheduling based on use of a Machine Learning (ML) model that utilizes historical data and real-time data. In some cases, the method 190 may further include a step of using context aware data integration to determine optimal timing of the remote operations when the endpoint devices are idle and/or when user productivity is least affected. The remote operations, for instance, may include script executions, surveys, device updates, mitigating issues in the private enterprise network, tracking device health metrics, network conditions, application status, and/or calendar integration. Based on evolving endpoint conditions and user activity, the method 190 may further include a step of reprioritizing tasks and/or remote operations as needed. Also, the method 190 may further include a step of receiving a trigger signal from a service desk operator to initiate execution of the remote operations.

In some respects, the focus of the remote orchestration may involve an intelligent rollout of remote actions (e.g., software updates, cleanup tasks, etc.) to user devices in a targeted, dynamic, and minimally disruptive manner. For example, this may capitalize on visibility into user activity and device health signals, which may be obtained using a client access app, cybersecurity app, etc.

Some features of the Remote Orchestration Systems and Methods may include:
1. Smarter Rollouts – Decisions may be based on when to deploy actions and/or may be based on user and device context. For example, this may include trigger actions when a user is inactive (e.g., after-hours deployment to reduce disruption). Also, dynamic orchestration may involve monitoring signals, such as user network activity, ensuring intelligent scheduling.
2. Gradual Rollout Strategies – Supports incremental rollout strategies to reduce risks. For example, this may start with a small percentage (e.g., 10%) of a group (i.e., trial or canary deployment), monitor results, and adjust rollout percentages to prevent system-wide impact from errors.
3. Machine Learning Integration – The orchestrator may be configured to use machine learning to monitor live feedback from devices. For example, if an update causes a device to crash, further rollouts are halted or adjusted.
4. Competitive Advantage with Advanced Digital Experience Monitoring – This may include embedding or incorporating the functionality described herein within a larger scale enterprise system or product. This may be a plugin or extension of the enterprise system for providing the additional functions of creating a workflow DAG ticketing process and/or orchestrating remote operations within a private enterprise network. In some cases, this may include combining device health insights with user behavior data. For example, an enterprise product (e.g., ZDX) may be configured to detect ongoing Zoom meetings on a device and then delay system updates to avoid disrupting critical tasks.

Some benefits of these systems may include at least:
a) Minimized User Inconvenience: Actions may be deployed when they are least disruptive to users’ workflow.
b) Risk Mitigation: Incremental and monitored rollouts prevent widespread outages or issues.
c) Competitive Edge: Competes with existing tools like VMware’s Intelligent Hub but distinguishes itself with enterprise software enhanced devices/products and user awareness.

In some embodiments, the programs 104, 106 may be configured together or separately in a control/management device, which may be local or remote. The Workflow Engine may be a comprehensive cross-domain solution combining internal security/access tools with external systems (e.g., Jira), offering higher-level holistic insights and automation. The Remote Actions Orchestrator may offer real-time insights from user experience apps to empower a more intelligent, adaptive, and user-friendly approach to remote action rollouts compared to conventional systems (e.g., VMware).

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method comprising steps of:
receiving telemetry information from a plurality of endpoint devices in an enterprise network, the telemetry information including device health data related to health of the plurality of endpoint devices, network status data related to a status of the enterprise network, and active application data related to a use of applications on the plurality of endpoint devices; and
orchestrating remote operations to be performed on the plurality of endpoint devices based on the device health data, network status data, and active application data.

2. The method of claim 1, wherein the remote operations are related to a roll-out procedure for rolling out a) new software, b) a software or firmware update, and/or c) a software fix or patch with respect to one or more software applications on each of the plurality of endpoint devices.

3. The method of claim 2, wherein the roll-out procedure is performed in groups of endpoint devices, wherein a first group is a trial group configured to send feedback with respect to success of the roll-out procedure.

4. The method of claim 3, wherein, in response to receiving feedback from the trial group that the roll-out procedure results in performance metrics within acceptable thresholds, further comprising a step of progressively expanding the roll-out procedure to continue to a next group.

5. The method of claim 3, wherein, in response to receiving feedback from the trial group that the roll-out procedure results in performance metrics outside of acceptable thresholds, further comprising steps of halting the roll-out procedure and rolling back changes of the roll-out procedure.

6. The method of claim 1, wherein the telemetry information is real-time telemetry information that further includes calendar data related to scheduled activities of a plurality of users of the plurality of endpoint devices.

7. The method of claim 6, wherein the step of orchestrating includes scheduling the remote operations to avoid disruptions a) that would negatively affect productivity of the plurality of users b) based on the calendar data, c) based on trends regarding hours when the plurality of users are active and inactive, and/or d) based on information regarding low-impact working time periods.

8. The method of claim 1, wherein the step of orchestrating includes predictive scheduling based on use of a Machine Learning (ML) model that utilizes historical data and real-time data.

9. The method of claim 1, further comprising a step of using context aware data integration to determine optimal timing of the remote operations when the endpoint devices are idle and/or when user productivity is least affected.

10. The method of claim 1, wherein the remote operations include one or more of script executions, surveys, device updates, mitigating issues in the enterprise network, tracking device health metrics, network conditions, application status, and calendar integration.

11. The method of claim 1, wherein, based on evolving endpoint conditions and user activity, further comprising a step of reprioritizing tasks and/or remote operations as needed.

12. The method of claim 1, further comprising a step of receiving a trigger signal from a service desk operator to initiate execution of the remote operations.

13. A back-end orchestration system comprising:
a processing device; and
memory configured to store a remote orchestration program having logical code with instructions for enabling the processing device to perform steps of
receiving telemetry information from a plurality of endpoint devices in an enterprise network, the telemetry information including device health data related to health of the plurality of endpoint devices, network status data related to a status of the enterprise network, and active application data related to a use of applications on the plurality of endpoint devices, and
orchestrating remote operations to be performed on the plurality of endpoint devices based on the device health data, network status data, and active application data.

14. The back-end orchestration system of claim 13, wherein the remote operations are related to a roll-out procedure for rolling out a) new software, b) a software or firmware update, and/or c) a software fix or patch with respect to one or more software applications on each of the plurality of endpoint devices, and wherein the roll-out procedure is performed in groups of endpoint devices, wherein a first group is a trial group configured to send feedback with respect to success of the roll-out procedure.

15. The back-end orchestration system of claim 14, wherein, in response to receiving feedback from the trial group that the roll-out procedure results in performance metrics within acceptable thresholds, further comprising a step of progressively expanding the roll-out procedure to continue to a next group.

16. The back-end orchestration system of claim 14, wherein, in response to receiving feedback from the trial group that the roll-out procedure results in performance metrics outside of acceptable thresholds, further comprising steps of halting the roll-out procedure and rolling back changes of the roll-out procedure.

17. The back-end orchestration system of claim 13, wherein the telemetry information is real-time telemetry information that further includes calendar data related to scheduled activities of a plurality of users of the plurality of endpoint devices, and wherein the step of orchestrating includes scheduling the remote operations to avoid disruptions a) that would negatively affect productivity of the plurality of users b) based on the calendar data, c) based on trends regarding hours when the plurality of users are active and inactive, and/or d) based on information regarding low-impact working time periods.

18. A non-transitory computer-readable medium configured to store a remote orchestration program having instructions for enabling a processing device to perform steps of:
receiving telemetry information from a plurality of endpoint devices in a private enterprise network, the telemetry information including device health data related to health of the plurality of endpoint devices, network status data related to a status of the private enterprise network, and active application data related to a use of applications on the plurality of endpoint devices; and
orchestrating remote operations to be performed on the plurality of endpoint devices based on the device health data, network status data, and active application data.

19. The non-transitory computer-readable medium of claim 18, wherein the remote operations are related to a roll-out procedure for rolling out a) new software, b) a software or firmware update, and/or c) a software fix or patch with respect to one or more software applications on each of the plurality of endpoint devices, and wherein the roll-out procedure is performed in groups of endpoint devices, wherein a first group is a trial group configured to send feedback with respect to success of the roll-out procedure.

20. The non-transitory computer-readable medium of claim 18, wherein the remote orchestration program is configured as a plugin or extension of an enterprise application that is primarily related to an observability platform for monitoring security and/or access with respect to the private enterprise network.
